(19) United States
(12) Patent Application Publication
(10) Pub. No.: US 2003/0215311 A1
(43) Pub. Date: Nov. 20, 2003

(54) Mobile adjustment device for standard mechanical interface (SMIF) arm

(75) Inventors: Chun-Huei Fan, Hsinchu (TW); Hon-Yi Ching, Hsinchu (TW); Chih-Chieh Wang, Bade City (TW); Chen-Chun Lee, Taichung (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/150,257

(22) Filed: May 17, 2002

(51) Int. Cl. B65G 1/133

(52) U.S. Cl. 414/217.1

(57) ABSTRACT

A mobile adjustment device for a standard mechanical interface (SMIF) arm is disclosed. The mobile adjustment device allows precise positioning of the SMIF arm relative to semiconductor processing equipment in three dimensions. The mobile adjustment device can include at least a number of wheeled legs, a bolt rod, and a sliding seat. The wheeled legs and the sliding seat allow for positioning the SMIF arm to two horizontal dimensions, whereas the bolt rod allows for positioning the SMIF arm in a vertical dimension, for a total of three dimensions.

### FIELD OF THE INVENTION

This invention relates generally to transfer systems for transferring semiconductor wafers, and more particularly to such transfer systems that include a standard mechanical interface (SMIF) arm.

### BACKGROUND OF THE INVENTION

The fabrication of semiconductor devices on semiconductor wafers requires that the semiconductor wafers be processed in a variety of different manners. Photolithography, chemical mechanical polishing (CMP), metal deposition, and so on, are all processes performed on semiconductor wafers in precise degrees to fabricate semiconductor devices. Usually, each of these different processes is performed using a different piece of semiconductor fabrication equipment. Therefore, a transport system is used to transport the semiconductor wafers among the different pieces of semiconductor fabrication equipment to achieve semiconductor device fabrication. Usually the semiconductor wafers are transported in pods.

FIG. 1 shows a top view of a traditional pod transport system 100. The system 100 particularly includes a conveyor belt 104 on which the pods may be transported among various stations 102a, 102b, . . . , 102n. Each of these stations 102a, 102b, . . . , 102n may be a separate piece of semiconductor fabrication equipment, a storage place to store pods and their semiconductor wafers, and so on. Overhead transfer (OHT) units 106 are able to move the pods vertically. The OHT units 106 are also referred to as OHT grippers, in that they grip the pods.

One particular area 108 of the system 100 of FIG. 1 is shown in more detail in a side view in FIG. 2. One of the OHT units 106 has a pod 202a that it is vertically lowering onto one of the load ports 204. One of the robot arms 208 has lowered on its vertical axis 206 to pick up the pod 202b that has already been lowered onto one of the load ports 204. The other of the robot arms 208 has risen on its vertical axis 206 to deposit the pod 202c onto one of the conveyor belts 104. In this way, pods 202 are moved from the OHT units 106 to the load ports 204, and ultimately to the conveyor belts 104. Furthermore, the OHT units 106 can vertically raise the pods 202 from the load ports 204.

The transport system 100 is specifically a standard mechanical interface (SMIF) system. A SMIF system is a type of isolation technology that includes mini-environments, pods, and tool interfaces. Mini-environments are enclosures that isolate the process equipment from the human environment. By providing a controlled airflow environment, particulate contamination is controlled and removed from critical semiconductor wafer environments. SMIF pods are sealed containers that hold and protect wafer-filled cassettes during storage, transport, and loading and unloading into the mini-environment only a machine, specifically a SMIF tool interface, can open them. Thus, the SMIF tool interfaces are automated mechanisms that open the SMIF pods and present the cassettes into the controlled environments of the processing tools.

A SMIF system is based on the understanding that it is easier and less expensive to maintain a smaller volume of air clean than a larger volume. This underlying principle is known as the isolation factor. The isolation factor is a measurement of the barrier capabilities of the system. Thus, a SMIF system operates on the philosophy of localized clean zones, in which SMIF equipment is used for contamination control only in the area immediately surrounding the wafers being processed. A SMIF foundry essentially includes a number of mini-cleanrooms through which semiconductor wafers pass without exposure to the ambient production facility air.

A SMIF arm is thus an arm, such as one of the arms 208 of FIG. 2, that loads and unloads semiconductor wafer cassettes from a SMIF pod to a piece of semiconductor processing equipment, such as one of the stations 102 of FIG. 1. SMIF arms, such as those available from Asyst Technologies, Inc., of Fremont, Calif., are typically large and heavy devices. This makes them difficult to move and adjust. However, when semiconductor fabrication assembly lines are reconfigured, the SMIF arms must be moved and adjusted precisely so that they properly load and unload semiconductor wafer cassettes. Typically, this results in significant downtime while the arms are moved and adjusted, which can be costly. Furthermore, if a SMIF arm fails and needs repair, it may need to be moved out, and a replacement arm moved in. However, such movement of the SMIF arm is also difficult, and can be expensive.

Therefore, there is a need to overcome these disadvantages associated with SMIF arms. There is a need to allow for more convenient movement and adjustment of SMIF arms. Such movement and adjustment should decrease the downtime resulting from semiconductor fabrication assembly line reconfiguration. For these and other reasons, therefore, there is a need for the present invention.

### SUMMARY OF THE INVENTION

The invention relates to a mobile adjustment device for a standard mechanical interface (SMIF) arm. The mobile adjustment device allows precise positioning of the SMIF arm relative to semiconductor processing equipment in three dimensions. The mobile adjustment device can include at least a number of wheeled legs, a bolt rod, and a sliding seat. The wheeled legs and the sliding seat allow for positioning the SMIF arm to two horizontal dimensions, whereas the bolt rod allows for positioning the SMIF arm in a vertical dimension, for a total of three dimensions.

Embodiments of the invention provide for advantages over the prior art. By fixing the SMIF arm to the mobile adjustment device, the SMIF arm can be precisely positioned relative to a desired piece of semiconductor processing equipment in three dimensions. When a semiconductor fabrication assembly line must be reconfigured, this means that SMIF arm reconfiguration is easily accomplished, reducing downtime of the assembly line, and thus being less costly for the semiconductor foundry. Still other advantages, aspects, and embodiments of the invention will become apparent by reading the detailed description that follows, and by referring to the accompanying drawings.

### BRIEF DESCRIPTION OF THE DRAWINGS

FIG. 1 is a diagram of a top view of a pod transfer system according to the prior art. The pod transfer system includes conveyors and overhead transfer (OHT) units for moving pods of semiconductor wafers to different semiconductor fabrication equipment.

FIG. 2 is a diagram of a side view of the pod transfer system of FIG. 1, in which the OHT units transport pods vertically to and from load ports.

FIG. 3 is a diagram of a side view of a mobile adjustment device for a standard mechanical interface (SMIF) arm, according to an embodiment of the invention.

FIG. 4 is a diagram of a perspective view of the mobile adjustment device of FIG. 3 for a SMIF arm. The mobile adjustment device of FIGS. 3 and 4 can be used in conjunction with the systems of FIGS. 1 and 2.

FIG. 5 is a flowchart of a method for using a mobile adjustment device for a SMIF arm, such as that of FIGS. 3 and 4, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

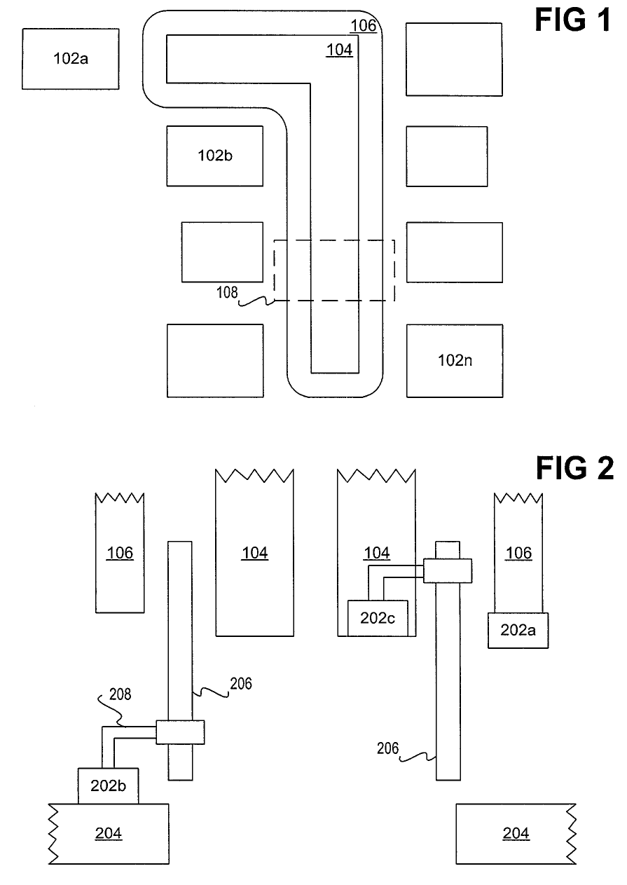

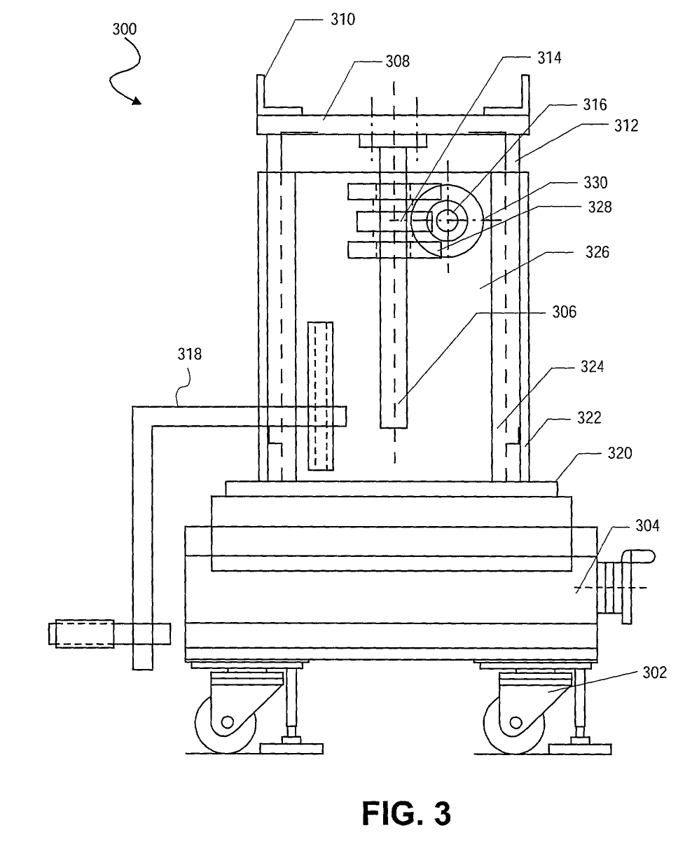

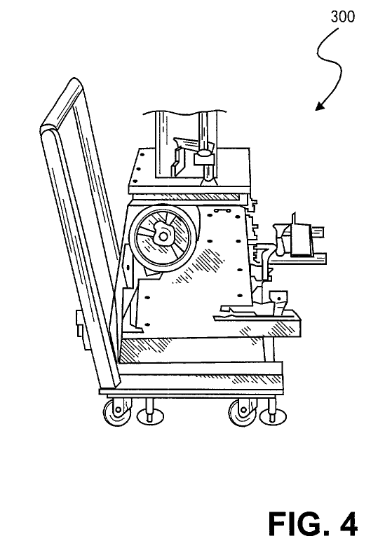

FIGS. 3 and 4 show a side view and a perspective view of a mobile adjustment device 300 for a standard mechanical interface (SMIF) arm, according to an embodiment of the invention. The mobile adjustment device 300 can be used in conjunction with the systems 100 and 200 of FIGS. 1 and 2, respectively, as well as in conjunction with other types of systems. The wheeled legs 302 allow the device 300 to be positioned precisely in a horizontal dimension, left and right. The sliding seat 304 allows the device 300 to be positioned precisely in another horizontal dimension, into and out of the plane shown in FIG. 3. The adjusting bolt rod 306 allows the device 300 to be positioned precisely in a vertical dimension, up and down. Thus, the mobile adjustment device 300 can be positioned precisely in any of three dimensions.

The SMIF arm is attached to the up/down platform 308, where it can be clamped to the fixed blocks 310. The up/down platform 308 is attached to the adjusting bolt rod 306, as well as to the sliding block 312. The cross gear 314 enables the sliding seat 304 to be moved in and out of the plane of FIG. 3, as indicated by the cross gear axis 316. By comparison, the wheeled handle 318 can be used (turned) to move the up/down platform 308 up and down via the bolt rod 306. A bottom connection plate 320 is situated over the sliding seat 304. Also present in the mobile adjustment device 300 are a sliding plate pressure block 322, a sliding seat turbine box 324, sliding seat turbine box left and right side caps 326, turbine box axial support upper and lower plates 328, and a turbine box axial support fixed cap 330. All of these components work in conjunction with the sliding seat 304 to allow the sliding seat to move horizontally in and out of the plane of FIG. 3.

More specifically, the sliding seat turbine box 324 is situated within the sliding plate pressure block 322. The turbine box axial support fixed cap 330 is secured to the sliding seat turbine box 324. The turbine box axial support upper and lower plates 328 are situated above and below the sliding seat turbine box 324, respectively. The sliding seat turbine box left and right side caps 326 are situated to either side of the sliding seat turbine box 324. The turbine box 324, in conjunction with the cross gear 314, allows movement of the sliding seat 304 in and out of the plane of FIG. 3. The various caps and support plates for the turbine box 324 enclose and support the turbine box 324, as can be appreciated by those of ordinary skill within the art.

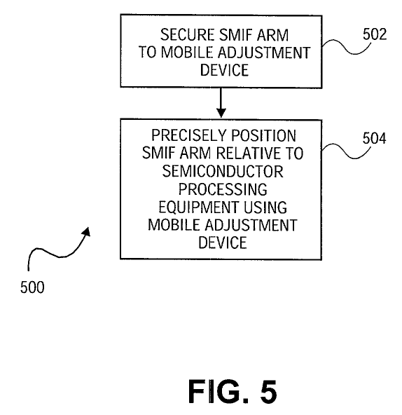

FIG. 5 shows a method 500 according to an embodiment of the invention. The method 500 is for use of a mobile adjustment device for a SMIF arm. Such a mobile adjustment device can be that of FIGS. 3 and 4 as has been described. First, a SMIF arm is secured to the mobile adjustment device for the SMIF arm (502). The SMIF arm is for loading and unloading pods that hold semiconductor wafer cassettes, as has been described, to and from semiconductor processing equipment. The SMIF arm can be secured to the up/down platform 308 of FIG. 3 of the mobile adjustment device 300 of FIG. 3, via the fixed block 310 of FIG. 3, for instance, in one embodiment.

Next, the SMIF arm is precisely positioned relative to the desired semiconductor processing equipment, using the mobile adjustment device (504). The precise positioning is preferably accomplished in three dimensions, by adjusting the mobile adjustment device for the SMIF arm. For instance, the bolt rod 306 of FIG. 3 may be adjusted by turning the wheeled handle 318 to precisely position the SMIF arm relative to the semiconductor processing equipment in a vertical direction, such as up and down in FIG. 3. As another example, the wheeled legs 302 of FIG. 3 may be adjusted (moved) to precisely position the SMIF arm relative to the semiconductor processing equipment in a horizontal direction, such as to the left and the right in FIG. 3. As a final example, the sliding seat 304 of FIG. 3, in conjunction with the cross gear 314 of FIG. 3, may be adjusted to precisely position the SMIF arm relative to the semiconductor processing equipment in a horizontal direction, such as in and out of the plane of FIG. 3.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

What is claimed is:

1. A mobile adjustment device for a standard mechanical interface (SMIF) arm comprising:
a plurality of wheeled legs to provide for horizontal movement of the SMIF arm in a first direction;
a platform on which the SMIF arm rests;
a bolt rod attached to the platform to provide for vertical movement of the SMIF arm;
a sliding seat situated over the plurality of wheeled legs to provide for horizontal movement of the SMIF arm in a second direction;
a sliding plate pressure block in which the bolt rod is situated; and,
a bottom connection plate securing the sliding seat to the sliding plate pressure block.

2. The adjustment device of claim 1, further comprising a fixed block situated on the platform to secure the SMIF arm to the platform.

3. The adjustment device of claim 1, further comprising a cross gear allowing for movement of the sliding seat.

4. The adjustment device of claim 1, further comprising a sliding seat turbine box situated within the sliding plate pressure block.

5. The adjustment device of claim 4, further comprising a turbine box axial fixed support cap secured to the sliding seat turbine box.

6. The adjustment device of claim 4, further comprising:
a turbine box axial support upper plate situated above the sliding seat turbine box; and,
a turbine box axial support lower plate situated below the sliding seat turbine box.

7. The adjustment device of claim 4, further comprising:
a sliding seat turbine box left side cap situated to one side of the sliding seat turbine box; and,
a sliding seat turbine box right side cap situated to another side of the sliding seat turbine box.

8. A system comprising:
a standard mechanical interface (SMIF) arm for loading and unloading pods holding semiconductor wafer cassettes to and from semiconductor processing equipment; and,
a mobile adjustment device for the SMIF arm to allow precise positioning of the SMIF arm relative to the semiconductor processing equipment in three dimensions.

9. The system of claim 8, the mobile adjustment device comprising a plurality of wheeled legs to provide for positioning of the SMIF arm in one of the three dimensions.

10. The system of claim 8, the mobile adjustment device comprising a bolt rod to provide for positioning of the SMIF arm in one of the three dimensions.

11. The system of claim 10, the mobile adjustment device further comprising a platform attached to the bolt rod on which the SMIF arm rests.

12. The system of claim 10, the mobile adjustment device further comprising a sliding plate pressure block in which the bolt rod is situated.

13. The system of claim 12, the mobile adjustment device further comprising a sliding seat turbine box situated within the sliding plate pressure block.

14. The system of claim 10, the mobile adjustment device further comprising a cross gear allowing for movement of the sliding seat.

15. The system of claim 8, the mobile adjustment device comprising a sliding seat to provide for positioning of the SMIF arm in one of the three dimensions.

16. The system of claim 15, the mobile adjustment device comprising a bottom connection plate securing the sliding seat to a sliding plate pressure block of the mobile adjustment device.

17. A method comprising:
securing a standard mechanical interface (SMIF) arm for loading and unloading pods holding semiconductor wafer cassettes to and from semiconductor processing equipment to a mobile adjustment device for the SMIF arm; and,
precisely positioning the SMIF arm relative to the semiconductor processing equipment in three dimensions by adjusting the mobile adjustment device for the SMIF arm.

18. The method of claim 17, wherein precisely positioning the SMIF arm relative to the semiconductor processing equipment comprises adjusting a bolt rod of the mobile adjustment device to precisely position the SMIF arm relative to the semiconductor processing equipment in a vertical direction.

19. The method of claim 17, wherein precisely positioning the SMIF arm relative to the semiconductor processing equipment comprises adjusting a plurality of wheeled legs of the mobile adjustment device to precisely position the SMIF arm relative to the semiconductor processing equipment in one of two horizontal directions.

20. The method of claim 17, wherein precisely positioning the SMIF arm relative to the semiconductor processing equipment comprises adjusting a sliding seat of the mobile adjustment device to precisely position the SMIF arm relative to the semiconductor processing equipment in one of two horizontal directions.
